(19) United States
(12) Patent Application Publication
(10) Pub. No.: US 2013/0318267 A1
(43) Pub. Date: Nov. 28, 2013

(54) APPARATUS AND METHOD FOR POLLING ADDRESSES OF ONE OR MORE SLAVE DEVICES IN A COMMUNICATIONS SYSTEM

(71) Applicant: Lexmark International, Inc., Lexington, KY (US)

(72) Inventor: Donald William Chapelle, Versailles, KY (US)

(73) Assignee: Lexmark International, Inc., Lexington, KY (US)

(21) Appl. No.: 13/959,387

(22) Filed: Aug. 5, 2013

Related U.S. Application Data
(63) Continuation of application No. 12/618,489, filed on Nov. 13, 2009.

(51) Int. Cl. G06F 13/40

(52) U.S. Cl. CPC G06F 13/4068
USPC 710/110

(57) ABSTRACT

An address polling method and system for communicating unique slave address values to a master device over a shared bus. The method includes receiving a request signal from the master device requesting that a slave address from each slave device coupled to the data line be sent to the master; causing, in a serial manner, the data line to be placed in logic states corresponding to bit values in a first slave address; and upon the data line being placed in a logic state that is different from a corresponding bit value of the first slave address, determining that another slave device is placing its slave address on the data line and temporarily entering an idle state until such other slave device has finished communicating its slave address to the master device.

### BACKGROUND

1. Field of the Invention

The present invention relates generally to communication over a shared, serial bus and in particular to an address polling method and system for communicating over a shared, open drain communication line.

2. Description of the Related Art

There exists a number of integrated circuit interface protocols in which a master communicates with a slave device using an address assigned thereto. With a shared bus over which more than one slave device may communicate with the master, each slave device has a unique address for use in communicating with the master. The slave address may be programmed by external inputs so that the slave device is configured with the address when the slave device powers up. Alternatively, the slave address is maintained in nonvolatile memory of the slave device and may be changed at any time. Interface protocol I²C is an exemplary interface protocol in which the master communicates with one or more slave devices, each of which has assigned to it a unique slave address.

During or immediately after power up, the master may not know the addresses of the slave devices that are connected to the shared bus and capable of communicating with the master. For example, device substitution or manufacturing changes may introduce different slave devices to the system. Printing devices may include a controller which functions as a master that is communicatively coupled one or more slave devices connected to cartridges, ink tanks or the like. Such cartridges and ink tanks may be replaced when the toner or ink therein has been depleted, and a new cartridge or ink tank inserted in its place into the printing device. Because each new cartridge/ink tank has a different slave device with a unique slave address, an operation is usually performed at or following power-up in order for the master to learn of the slave devices that are currently coupled thereto.

One approach exists for a master to learn the unique addresses of the slave devices which are capable of communicating with the master. In the I²C protocol, the master may attempt to obtain the addresses of the slave devices by sending a query containing a unique slave address, and waiting for a reply. If there is a reply from a slave device having the unique address, the master knows of the existence of the slave device. On the other hand, if there is no reply, the master knows that no slave exists that has the unique address. As can be seen, a master would have to send a query for each possible slave address in order for the master to be made known of every slave device coupled to the I²C bus. For systems in which a slave address may be several bits or bytes in length, this approach may result in an inefficient amount of time being spent by the master to learn of all slave devices coupled thereto.

Based upon the foregoing, there is a need for a more efficient approach for a master to learn of the slave addresses of those slave devices communicatively coupled thereto.

### SUMMARY OF THE INVENTION

Embodiments of the present invention overcome shortcomings in prior communication systems and thereby satisfy a significant need for a protocol for communicating slave addresses to a master over a shared bus.

In accordance with an exemplary embodiment of the present invention, there is shown a method of communicating with a master over a shared bus having a data line, including receiving a request signal from the master requesting a slave address from each slave device coupled to the data line be sent to the master; causing, in a serial manner, the data line to be placed in logic states corresponding to bit values in a first slave address; and upon the data line being placed in a logic state that is different from a corresponding bit value of the first slave address, temporarily entering an idle state until another slave device has completed sending its slave address to the master.

Another exemplary embodiment of the present invention includes a slave device having an interface port for coupling to a shared bus having a clock line and a data line; nonvolatile memory for storing a first slave address corresponding to the slave device; and a controller communicatively coupled to the interface port and to the nonvolatile memory. Upon the interface port receiving a request signal from a master requesting that a slave address of each slave device coupled to the shared bus be sent to the master, the controller controls the interface port to cause, in a serial manner, the data line to be placed in logic states corresponding to bit values in the first slave address. Upon the data line being placed in a logic state that is different from a corresponding bit value of the first slave address, the controller controls the interface port to temporarily enter an idle state until another slave device has completed sending the slave address thereof to the master.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 is a schematic diagram of a communication system according to an exemplary embodiment of the present invention;

FIG. 2 is a flow chart illustrating activity undertaken by one or more devices according to an exemplary embodiment of the present invention; and

FIG. 3 is a flow chart illustrating activity undertaken by one or more devices according to an exemplary embodiment of the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

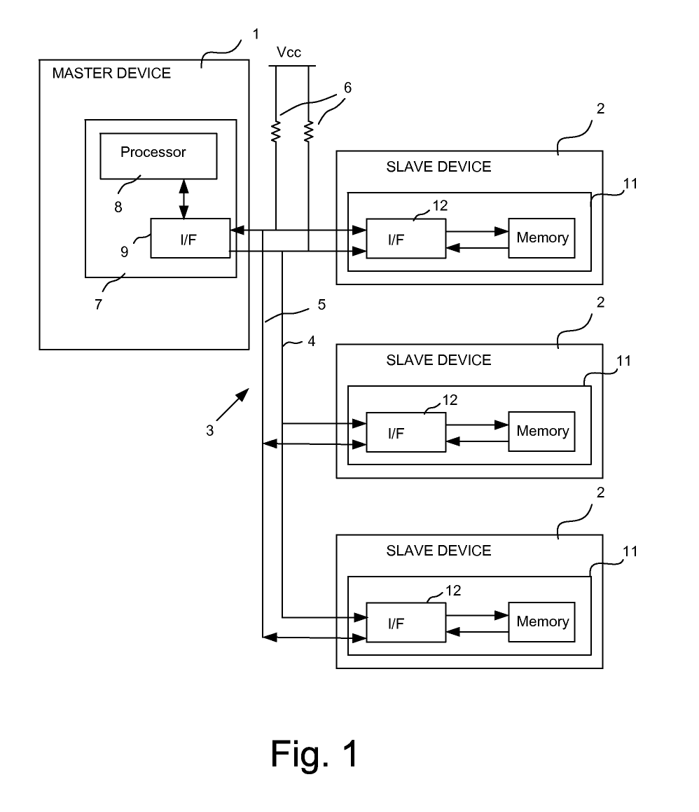

FIG. 1 shows a system for communicating between a master device 1 and one or more slave devices 2 in accordance with an exemplary embodiment of the present invention. Master device 1 and one or more slave devices 2 communicate with each other over a shared bus 3. Shared bus 3 may be a bus over which information is communicated between master device 1 and a slave device 2. As depicted in FIG. 1, more than one slave device 2 may be coupled to shared bus 3 for communicating with master device 1. In an exemplary embodiment of the present invention, shared bus 3 may include a clock line 4 and a data line 5. Clock line 4 may be used to synchronize communication between master device 1 and slave device(s) 2. In particular, master device 1 may provide the clock or other timing signal to clock line 4 for synchronizing communication between devices. Data line 5 may be used for sending information between master device 1 and slave device(s) 2. In an exemplary embodiment of the present invention, data line 5 may be a single line such that information is transmitted between devices in a serial manner. Alternatively, data line 5 may be more than one line for sending information in parallel. Coupled to each of clock line 4 and data line 5 may be a pull-up device 6 which serves to relatively weakly pull the voltage appearing on the corresponding line to the supply voltage Vcc corresponding to a logic one voltage level, in an absence of any device (master device 1 or slave device 2) driving the line to ground, corresponding to a logic zero voltage level. Pull-up device 6 may be a resistive element. In this way, data line 5 may be viewed as being configured in an open drain, wired-OR arrangement in which a logic zero level appears on data line 5 due to one or more devices driving data line 5 to the ground potential, and a logic one level appears on data line 5 when no device coupled to data line 5 drives data line 5 to the ground potential, thereby allowing pull-up device 6 to pull data line 5 to the supply voltage Vcc. Open drain, wired-OR bus configurations are well known, so no further description thereof will be provided for reasons of simplicity.

In accordance with an exemplary embodiment of the present invention, master device 1 may initiate communication between master device 1 and slave device(s) 2. Master device 1 may include a controller 7 for, among other things, controlling communication with slave devices 2 that are coupled to shared bus 3. Controller 7 may include a processor 8 with nonvolatile memory for storing firmware executable by processor 8 for communicating with slave devices 2. Controller 6 may further include a master interface 9 for transmitting and receiving signals over shared bus 3 in conformance with the requisite communication protocol. Controller 7 may be implemented in an integrated circuit, such as an application specific integrated circuit (ASIC).

Slave device 2 may include a slave controller 11 for communicating with master device 1 over shared bus 3. Controller 11 may include a slave interface 12 for transmitting and receiving signals over shared bus 3 in conformance with the requisite communication protocol. Controller 11 may include non-volatile memory for storing slave address information that is unique to the particular slave device 2 and used by master device 1 for communicating therewith. Controller 11 may execute firmware stored in its non-volatile memory for communicating with master device 1. Controller 11 may be implemented in an integrated circuit, such as an ASIC.

As mentioned above, master device 1 and slave devices 2 communicate with each other over shared bus 3. Master device 1 and slave devices 2 may follow a specific protocol for communicating over shared bus 3. For example, master device 1 and slave devices 2 may utilize the I²C communication protocol. It is understood, however, that master device 1 and slave devices 2 may communicate with each other using other communication protocols. Master device 1 and slave devices 2 may communicate with each other using protocols for open-drain configurations like System Management Bus (SMB) and Apple Desktop Bus (ADB).

As mentioned above, at power up the master device 1 may not know the addresses of the slave devices 2 that are connected to the shared bus 3 and capable of communicating with the master device 1. This may be at least partly due to the fact that slave devices 2 coupled to the master device 1 may be replaced from time to time with new slave devices 2 having different slave addresses assigned thereto. Embodiments of the present invention provide an address polling methodology for effectively communicating the unique slave addresses with master device 1. The address polling method will be described below with respect to the I²C communication protocol, but as mentioned above it is understood the method is not protocol-specific and is applicable to any of a number of other communication protocols.

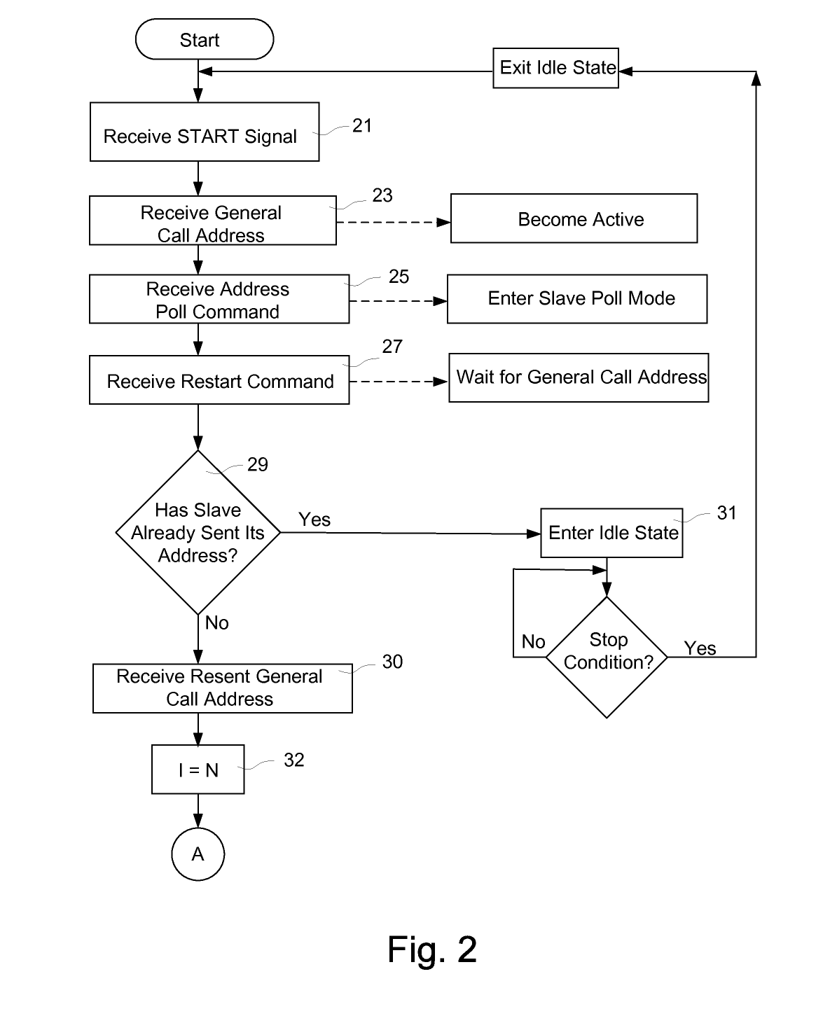

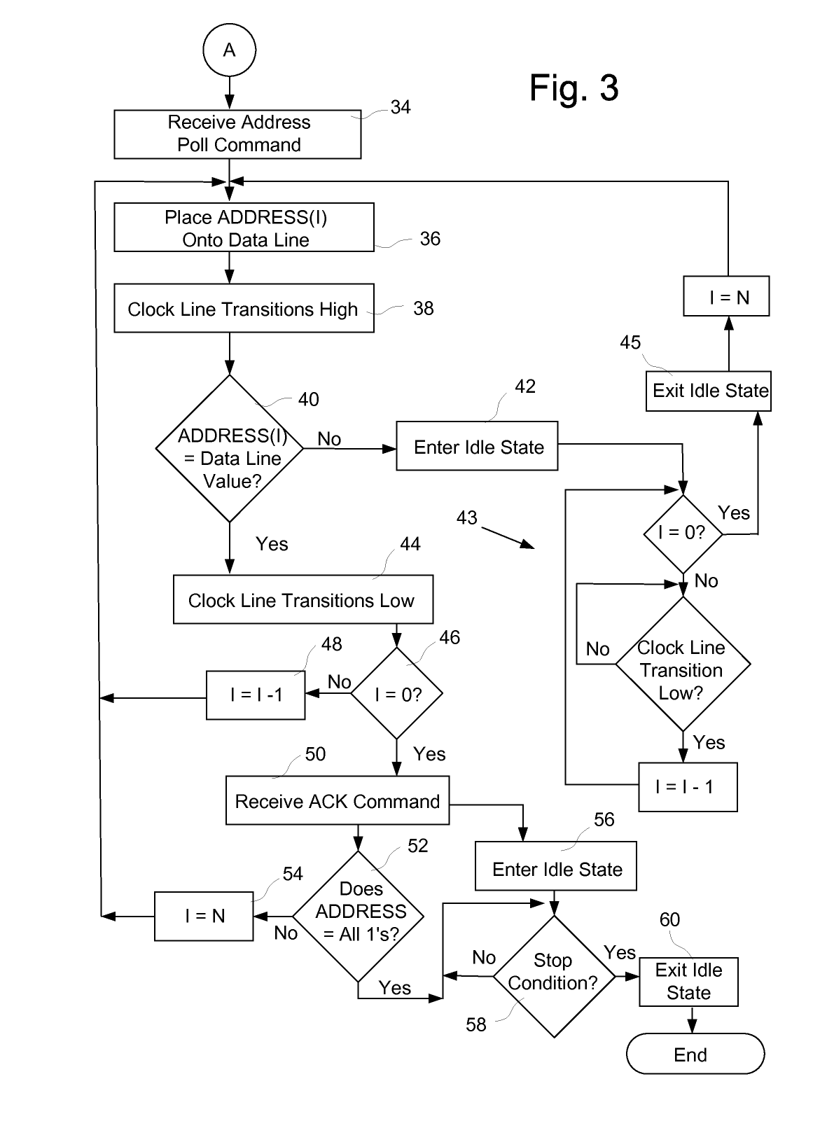

FIGS. 2 and 3 illustrate an address polling method for master device 1 and slave devices 2 in accordance with exemplary embodiments of the present invention. For reasons of simplicity, FIGS. 2 and 3 primarily illustrate the address polling method from the perspective of slave device 2. Initially, master device 1 sends a start command to slave devices 2 which is received at 21. Reception of the start command causes slave devices 2 to prepare to receive a device address. Master device 1 sends a general call address to slave devices 2 which when received at 23 causes each slave device 2 to become active. Master device 1 then may send the address polling command which when received at 25 causes slave devices 2 to enter a slave poll mode and wait for a restart command from master device 1, per I²C communication protocol. Master device 1 may then send the restart command to slave devices 2, which when received at 27 causes slave devices 2 to wait for master device 1 to resend the general call address command.

Next, each slave 2 determines at 29 whether it has already sent its unique slave address to master device 1. If a slave device 2 determines that its slave address had already been sent to master device 1, that slave device 2 enters into an idle mode at 31 until a stop condition occurs, which indicates that the address polling operation has concluded. Slave devices 2 which have not already sent their corresponding slave address to master device 1 remain active.

Master device 1 resends the general call address to slave devices 2 and releases data line 5 so as to allow slave devices 2 to drive data line 5 and place information thereon following receipt of the general call address at 30. Variable I is set to the value N at 32, where N corresponds to a number of bits in the slave addresses. Referring to FIG. 3, master device 1 may send an address change command to slave devices 2, which when received at 34 causes each slave device 2 which is not idle to simultaneously place on data line 5 the most significant bit (MSB), i.e., the I-th bit, of the corresponding slave address of the slave device 2. Slave devices 2 having a slave address with an MSB of logic zero drive data line 5 to a logic zero state. Slave devices 2 having a slave address with an MSB of logic one, on the other hand, will release (i.e., not drive) data line 5 due to the open drain, wired OR configuration of data line 5, and will instead allow pull up device 6 to pull data line 5 to the logic one state in the absence of any other slave device 2 driving data line 5 to the logic zero state. Thereafter, master device 1 may drive clock line 4 to logic one state at 38.

At 40, each slave device 2 that is not idle determines whether the value on data line 5 matches the MSB of the slave address of slave device 2. If there is no match, this means that the slave device 2 which released and/or allowed data line 5 to be pulled to a logic one state (by pull-up device 6) instead saw data line 5 being driven to a logic zero state by at least one other slave device 2, thereby indicating that at least one other slave device 2 has a slave address with its MSB of logic zero. The slave device 2 which released data line 5 thus determines that at least one other slave device 2 has a slave address with a lower slave address value that its slave address, and the slave device 2 having the higher slave address value enters an idle state at 42 to allow the at least one other slave device 2 having the lower slave address value to transfer the remaining portion of the corresponding lower slave address to master device 1. Slave device 2 having the higher slave address temporarily remaining in the idle state can be illustrated in blocks 43 in which the value of variable I is decremented with each occurrence of a falling edge of clock line 4, until the value of variable I is zero.

Upon the value of variable I being zero, indicating that another slave device 2 has completed communicating its slave address with master device 1, the idled slave device 2 exits the idle state at 45, resets variable I to N at 47, and begins again to place the MSB of its slave address on data line 5 at 36.

Next, master device 1 drives clock line low at 44, which captures the logic value appearing on data line 5. At 46, it is determined whether the variable I equals zero. If variable I does not equal zero, variable I is decremented at 48 and the method returns to block 36 which results in each active slave device 2, controlling data line 5 to have placed thereon the value of the next highest bit, the I-th bit, in the slave device's corresponding slave address. Acts 36-46 are repeated with respect to the next highest (I-th) bit of the slave addresses being placed on data line 5, with each slave device 2 having a larger slave address than another slave device 2 being again placed in the idle state at 42. By repeating blocks 36-48 in this manner for each bit in the slave addresses, all slave devices 2 except for the slave device 2 having the smallest slave address enters the idle state and the slave device 2 having the smallest slave address places onto data line 5 each bit value of its slave address for capture by master device 1. When all bits of the slave device 2 having the smallest slave address have been captured by master device 1, master device 1 sends an acknowledgement to the slave devices 2 at 50. The slave device 2 having the smallest slave address then enters the idle state at 56 and remains there until a stop condition occurs at 58.

At 52, a determination is made by master device 1 whether each bit in the slave address received thereby is a logic one value, thereby indicating that all slave addresses have been previously received, whereupon master device 1 issues a stop condition to the slave devices 2 to end the address polling. Following master device 1 issuing the stop condition, all idle slave devices 2 become active at 60 and await the next communication from master device 1. If the determination at 52 is negative, at 54 the variable I is reset to the value N and blocks 36-56 are repeated for master device 1 to receive the next smallest slave address from the remaining slave devices 2 that have yet to communicate their slave addresses to master device 1. Blocks 36-56 are repeated in this manner for sending to master device 1 the slave address of each slave device coupled to shared bus 3.

In one exemplary embodiment, the MSB of each slave address may be a logic zero value so that if the value of data line 5 is ever at a logic one state when slave devices 2 place their MSBs onto data line 5, master device 1 is able to easily determine that each slave device 2 has already communicated its slave address to master device 1, whereupon master device 1 may issue a stop condition to end address polling.

As can be seen, the address polling method according to exemplary embodiments of the present invention allows for a relatively fast approach to effectively informing master device 1 of the slave address of each slave device 2 coupled to shared bus 3.

In an exemplary embodiment of the present invention, master device 1 may be an imaging apparatus, such as a printer, and slave devices 2 may be replaceable cartridges, tanks or the like for holding toner or ink. In this embodiment, master device 1 may include a number of additional components and modules, such as a print engine for imparting toner or ink onto a sheet of media; a media feed mechanism for picking the media sheet from a media sheet stack and moving the picked sheet to the print engine and subsequently to a media output tray; a user interface for receiving user commands and providing operation related information to the user; and an interface for communicating with a computing device. Such components and modules of an imaging apparatus are known in the art and will not be described further for reasons of simplicity. Alternatively, it is understood that master device 1 may be any apparatus for, among other things, communicating with slave devices 2 that are coupled to shared bus 3.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. For example, it is understood that the variable I may be initially set to zero at block 32 and incremented at block 48 so that slave address values may be placed on data line 5 sequentially from least significant bit to MSB.

It is intended that the scope of the invention be defined by the claims appended hereto.

What is claimed is:

1. A method of communicating with a master over a shared bus having a data line, comprising:
receiving, by a slave device, a request signal from a master requesting a slave address from each slave device coupled to the data line be sent to the master;
controlling, by the slave device, the data line for the data line to be sequentially placed in logic states corresponding to bit values in a first slave address of the slave device; and
upon the data line being placed in a logic state that is different from the corresponding bit value of the first slave address, temporarily entering an idle state until another slave device has completed sending a slave address thereof to the master.

2. The method of claim 1, further comprising entering the idle state when all bits of the first slave address have been placed on the data line.

3. The method of claim 1, wherein the controlling comprises driving the data line to a first logic state when the corresponding bit value of the first slave address is the first logic state, and releasing the data line when the corresponding bit value of the first slave address is a second logic state.

4. The method of claim 3, wherein the first logic state is a logic zero state and the second logic state is the logic one state.

5. The method of claim 1, further comprising monitoring the logic state of the data line and determining whether the monitored logic state of the data line is the same as the corresponding bit value of the first slave address, wherein entering the idle state is based upon the determination.

6. The method of claim 1, wherein the controlling is performed in a serial manner from most significant bit of the first slave address to least significant bit thereof.

7. The method of claim 1 further comprising counting a first number of clock cycles from a time when the controlling began, wherein entering the idle state comprises entering the idle state for a second number of clock cycles, the second number of clock cycles corresponding to a number of bits in the first address less the first number of clock cycles.

8. The method of claim 7, further comprising exiting the idle state upon completion of the second number of clock cycles, repeating the act of controlling unless the data line is again placed in a logic state that is different from the corresponding bit value of the first slave address and reentering the idle state in response thereto.

9. The method of claim 8, further comprising, upon completion of controlling the data line for the data line to be sequentially placed in the logic state corresponding to each bit value of the first slave address, entering the idle state until an indication from the master is received that all slave addresses have been received thereby.

10. A slave device, comprising:
an interface port for coupling to a shared bus having a clock line and a data line;
nonvolatile memory for storing a first slave address corresponding to the slave device;
a controller communicatively coupled to the interface port and to the nonvolatile memory, the controller configured to:
upon the interface port receiving a request signal from a master requesting that a slave address of each slave device that is coupled to the shared bus be sent to the master, controlling the interface port for the data line to be serially placed in logic states corresponding to bit values in the first slave address; and
upon the data line being placed in a logic state that is different from the corresponding bit value of the first slave address, controlling the interface port to temporarily enter an idle state until another slave device has completed sending a slave address thereof to the master.

11. The slave device of claim 10, wherein the interface port drives the data line to a first logic state when the corresponding bit value of the first slave address is the first logic state, and releases the data line when the corresponding bit value of the first slave address is a second logic state.

12. The slave device of claim 10, wherein the controller is configured to determine whether the another slave device caused the data line to be placed in a logic state that is different from the corresponding bit value of the first slave address, and to enter the idle state in response.

13. The slave device of claim 10, wherein the interface port enters the idle state following a completion of the first slave address being placed on the data line.

14. The slave device of claim 10, wherein following the another slave device sending the slave address thereof to the master, the controller controls the interface port for the data line to be placed in logic states corresponding to the bit values in the first slave address.

15. The slave device of claim 10, wherein the interface port causes the first address to be serially placed on the data line from most significant bit to least significant bit.

16. (canceled)
